(19) United States
(12) Patent Application Publication
(10) Pub. No.: US 2026/0249363 A1
(43) Pub. Date: Aug. 27, 2026

(54) VIBRATION DAMPED CUTTER HOLDER

(71) Applicant: NATIONAL CHUNG HSING UNIVERSITY, Taichung City (TW)

(72) Inventors: CHIEN-HUNG LIU, Taichung City (TW); MING-YUAN SHEN, Taichung City (TW)

(21) Appl. No.: 19/309,495

(22) Filed: Aug. 25, 2025

(30) Foreign Application Priority Data
Feb. 25, 2025 (TW) 114106851

(51) Int. Cl. B23B 29/02; B23B 29/12

(52) U.S. Cl. CPC B23B 29/022; B23B 29/12; B23B 2228/36

(57) ABSTRACT

A vibration-damping cutter holder having a cutter handle and a cutter holder is provided. An area on an outer surface of the cutter handle, the cutter holder, or both is having a first length axially. A part or whole of the area of the cutter handle, the cutter holder, or both the cutter handle and holder is covered with a 3-dimensional member with a fourth length. The 3D damping member consists of multiple layers of anti-vibration fiber and resin parts. The anti-vibration fiber is formed by at least one fiber or a combination of at least two fibers. The anti-vibration fiber is connected with the resin parts to form an integrated body.

### FIELD OF THE INVENTION

The present invention relates to a vibration-damping cutter holder, especially to a vibration-damping cutter holder with three-dimensional damping members for reducing vibration transmission.

### BACKGROUND OF THE INVENTION

A conventional vibration-damping cutter holder revealed in Chinese Pat. Pub. No. CN 117086345A and refer to FIG. 1, a main body of the boring bar adopts a multi-layer cylindrical structure which is composed of a base rod (core shaft), a damping layer, and a constraint layer 5. The constraint layer 5 is made of carbon fiber cloth and arranged symmetrically with winding angles are 0°, 5°, −5°, 0°. The damping layer is nested on the surface of the base rod and bonded by adhesive and cured after cooling.

Refer to Chinese Pat. Pub. No. CN108580995B and FIG. 5, a horizontal assembly-type vibration-damping milling cutter features on that a carbon fiber composite material 12 is filled in an inner cavity of a hard alloy layer using epoxy adhesive. A damping layer 7 is made of foamed aluminum rods, and mounted in the inner cavity of the carbon fiber composite material using epoxy adhesive for providing damping effect.

Refer to Chinese Pat. Pub. No. CN108097989A and FIG. 3, a boring bar covered with carbon fiber sleeve is provided. A metal holder 1 is located in a carbon fiber mounting layer 3 and a metal case 5 is mounted around the carbon fiber mounting layer 3. A pin key 4 is inserted between the carbon fiber mounting layer 3 and the metal case 5 for fixing.

Refer to Chinese Pat. Pub. No. CN220127621U, FIG. 2 and claim 6, an outer surface of a handle 1 is connected to and fixed on a fixing plate 14. An outer surface of the fixing plate 14 is made of carbon fiber composite plate and provided with a fixing slot.

Refer to claim 1 of Chinese Pat. Pub. No. CN107378012B, materials for a handle 8 and a holder 7 are resin-based carbon fiber reinforced plastic composed of resin base and continuous carbon fiber. The resin base is bisphenol A epoxy resin and a volume ratio of the carbon fiber is controlled at 72%.

Refer to claim 1 of Chinese Pat. Pub. No. CN209303740U, an inner surface of the carbon fiber composite thin plate 3 is closely attached to an outer surface of a tool bar 4. A surface roughness of the inner surface of the carbon fiber composite thin plate 3 and the outer surface of a tool bar 4 are both above Ra=0.5 and are both attached to each other closely.

However, the above cutter or cutter holder still have certain problems. Refer to publications of CN102574212B, JP2010120108A, JP 2005199391A, JPH 08229711A, and KR 890011661A derived, no 3D damping structure for reducing vibration transmission or vibration attenuation is provided. Thus there is room for improvement and there is a need to provide a new design which solves the problems.

### SUMMARY

Therefore, it is a primary object of the present invention to provide a vibration-damping cutter holder in which an inner surface, an outer surface, or both the inner and the outer surface is/are provided with at least one 3-dimensional damping member for continuous reduction of vibrations and preventing heat build-up.

In order to achieve the above object, a vibration-damping cutter holder according to the present invention includes an outer surface disposed on both a cutter handle and a cutter holder and an inner surface arranged at a hollow space inside the vibration-damping cutter holder.

The vibration-damping cutter holder features on that the inner surface, the outer surface, or their combinations are provided with at least one 3-dimensional damping member for reducing vibration transmission. A length of the 3-dimensional (3D) damping member is not over a length of the inner surface, a length of the outer surface, or a length of a combination of the inner and the outer surfaces. The 3D damping member consists of multiple layers of anti-vibration fiber and resin parts. The anti-vibration fiber is selected from the group consisting of liquid crystal polymer (LCP) fiber, aromatic polyamide (aramid) fiber, carbon fiber, boron fiber, basalt fiber, glass fiber, and a combination thereof. The anti-vibration fiber is stacked from 3 to 15 layers and connected with the resin parts to form an integrated body.

### BRIEF DESCRIPTION OF THE DRAWINGS

FIG. 1 is a perspective view of an embodiment of a vibration-damping cutter holder showing an area of an outer surface of a cutter holder according to the present invention;

FIG. 2 is a perspective view of an embodiment of a vibration-damping cutter holder showing an area between an outer surface of a cutter handle and an outer surface of a cutter holder according to the present invention;

FIG. 3 is a radial sectional view of an embodiment showing a 3-dimensional damping member completely covering an outer surface of a vibration-damping cutter holder according to the present invention;

FIG. 4 is a partial enlarged view of a part E of the embodiment in FIG. 3 according to the present invention;

FIG. 5 is a radial sectional view of an embodiment showing a 3-dimensional (3D) damping member covering a part of an outer surface of a vibration-damping cutter holder according to the present invention;

FIG. 6 is a partial enlarged view of a part F of the embodiment in FIG. 5 according to the present invention;

FIG. 7 is a planar view of the embodiment in FIG. 6 combined with FIG. 1 and FIG. 2 extended from line A-B to line CD showing 3D damping members arranged axially according to the present invention;

FIG. 8 is a planar view of the embodiment in FIG. 6 combined with FIG. 1 and FIG. 2 extended from line A-B to line CD showing two sets of 3D damping members arranged vertically and axially according to the present invention;

FIG. 9 is a planar view of the embodiment in FIG. 6 combined with FIG. 1 and FIG. 2 extended from line A-B to line CD showing two vertically-arranged 3D damping members and another damping member arranged alternately according to the present invention;

FIG. 10 is a planar view of the embodiment in FIG. 6 combined with FIG. 1 and FIG. 2 extended from line A-B to line CD showing two vertically-arranged 3D damping members and other two vertically-arranged 3D damping members arranged alternately according to the present invention;

FIG. 11 is a planar view of the embodiment in FIG. 6 combined with FIG. 1 and FIG. 2 extended from line A-B to line CD showing 3D damping members arranged in a non-axially way according to the present invention;

FIG. 12 is a planar view of the embodiment in FIG. 6 combined with FIG. 1 and FIG. 2 extended from line A-B to line CD showing 3D damping members arranged in another non-axial way according to the present invention;

FIG. 13 is a radial sectional view of another embodiment in which a long slot is mounted to an outer surface of a vibration-damping cutter holder and 3D damping members are mounted in the long slot according to the present invention;

FIG. 14 is a partial enlarged view of a part G of the embodiment in FIG. 13 showing a level of a top surface of the 3D damping member is higher than a level of the outer surface according to the present invention;

FIG. 15 is a partial enlarged view of a part G of the embodiment in FIG. 13 showing a level of a top surface of the 3D damping member is flush with a level of the outer surface according to the present invention;

FIG. 16 is a planar view of the embodiment in FIG. 13 combined with FIG. 1 and FIG. 2 extended from line A-B to line CD showing long slots arranged axially according to the present invention;

FIG. 17 is a planar view of the embodiment in FIG. 13 combined with FIG. 1 and FIG. 2 extended from line A-B to line CD showing two sets of long slots arranged vertically and axially according to the present invention;

FIG. 18 is a planar view of the embodiment in FIG. 13 combined with FIG. 1 and FIG. 2 extended from line A-B to line CD showing two vertically-arranged long slots and another long slot arranged alternately according to the present invention;

FIG. 19 is a planar view of the embodiment in FIG. 13 combined with FIG. 1 and FIG. 2 extended from line A-B to line CD showing two vertically-arranged long slots and other two vertically-arranged long slots arranged alternately according to the present invention;

FIG. 20 is a planar view of the embodiment in FIG. 13 combined with FIG. 1 and FIG. 2 extended from line A-B to line CD showing long slots arranged in a non-axially way according to the present invention;

FIG. 21 is a planar view of the embodiment in FIG. 13 combined with FIG. 1 and FIG. 2 extended from line A-B to line CD showing long slots arranged in another non-axial way according to the present invention;

FIG. 22 is a perspective view of a further embodiment showing a 3D damping member on whole area of an inner surface of a vibration-damping cutter holder according to the present invention;

FIG. 23 is a perspective view of a further embodiment showing a 3D damping member on a part of an inner surface of a cutter handle and a cutter holder according to the present invention;

FIG. 24 is a radial sectional view of an embodiment in which an inner surface of a vibration-damping cutter holder is completely covered with a 3D damping member according to the present invention;

FIG. 25 is a partial enlarged view of a part H of the embodiment in FIG. 24 according to the present invention;

FIG. 26 is a radial sectional view of an embodiment in which a part of an inner surface of a vibration-damping cutter holder is covered with a 3D damping member according to the present invention;

FIG. 27 is a partial enlarged view of a part J of the embodiment in FIG. 26 according to the present invention;

FIG. 28 is a sectional view of an embodiment of a vibration-damping cutter holder provided with a 3D damping member formed by an upper damping laminate and a lower damping laminate according to the present invention;

FIG. 29 is a partial enlarged view of a K part of the embodiment in FIG. 28 showing an upper damping laminate and a lower damping laminate separated from each other according to the present invention;

FIG. 30 is a partial enlarged view of a part K of the embodiment in FIG. 28 according to the present invention;

FIG. 31 is a radial sectional view of an embodiment showing both an inner surface and an outer surface of a vibration-damping cutter holder covered with a 3D damping member according to the present invention;

FIG. 32 is a partial enlarged view of a part L of the embodiment in FIG. 31 according to the present invention;

FIG. 33 is a radial sectional view of an embodiment showing an outer surface and a part of an inner surface of a vibration-damping cutter holder covered with a 3D damping member according to the present invention;

FIG. 34 is a partial enlarged view of a part M of the embodiment in FIG. 33 according to the present invention;

FIG. 35 is a radial sectional view of an embodiment showing a part of an outer surface and an inner surface of a vibration-damping cutter holder covered with a 3D damping member according to the present invention;

FIG. 36 is a partial enlarged view of a part N of the embodiment in FIG. 35 according to the present invention;

FIG. 37 is a radial sectional view of an embodiment showing a part of an outer surface and a part of an inner surface of a vibration-damping cutter holder covered with a 3D damping member according to the present invention;

FIG. 38 is a partial enlarged view of a part P of the embodiment in FIG. 37 according to the present invention.

### DETAILED DESCRIPTION

In the figures, a thickness of composite, fiber, or laminates is enlarged in order to describe more clearly. In the specification, the same reference signs represent the same materials. It should be understood that the materials including composite, fiber, laminates, etc. are on another material or connected to another material, this means the materials are directly located at another material, directly connected to another material, or there is an intermediate layer material existed between them. When the material is described to be directly on another material or directly connected to another material, it means there is no intermediate layer material. The “connection” mentioned in the specification can be either physical or chemical. In the specification, resin parts 4 not cured yet including the resin parts 4 soaked in anti-vibration fiber 3 are called pre-impregnated materials (prepreg). As to the 3-dimensional (3D) damping member 2 not cured, it is called a prepreg laminate.

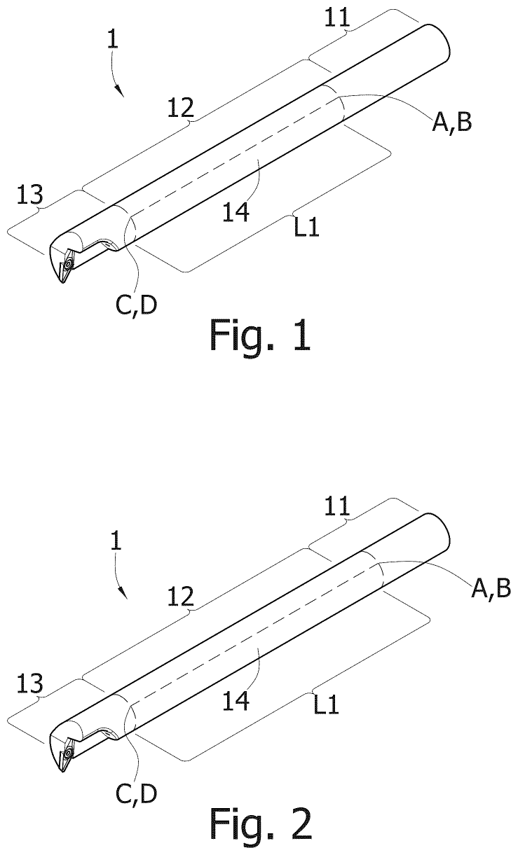

Refer to FIG. 1 and FIG. 2, a vibration-damping cutter holder 1 according to the present invention includes a cutter handle 11, a cutter holder 12, and a cutter 13. The cutter handle 11 is disposed on a top of the cutter holder 12 and the cutter 13 is arranged at a bottom of the cutter holder 12. According to different cutting purposes or functions required, various kinds of the cutter 13 including an end mill, a lathe tool, a parting tool, and engraving tool are provided.

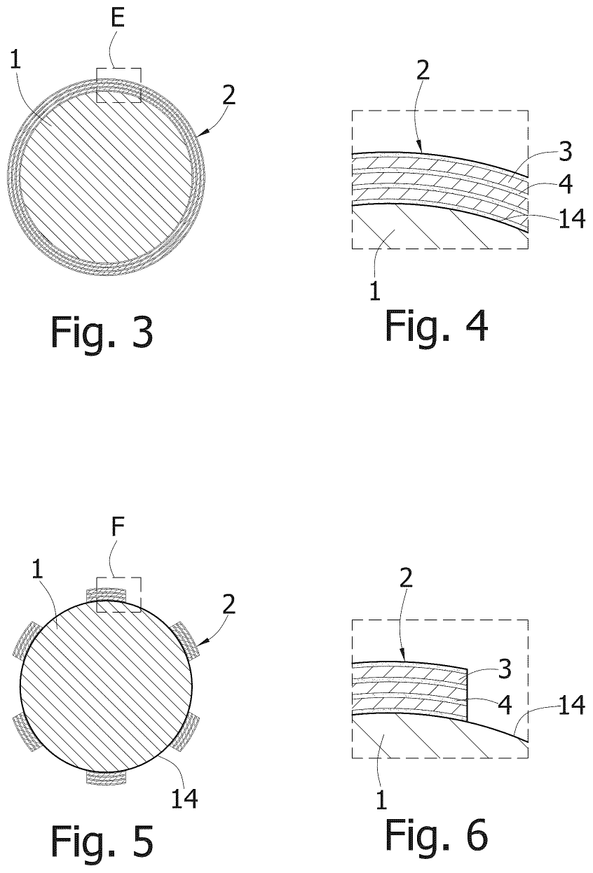

In a first embodiment of the present invention, refer to FIG. 1-4, an area of an outer surface 14 of the cutter holder 12, both the cutter handle 11 and the cutter holder 12, or the cutter handle 11 is having a first length L1. The 3D damping member 2 with a fourth length L4 is arranged at the whole area. Or as shown in FIG. 1, FIG. 2, FIG. 5, and FIG. 6, the 3D damping member 2 with the fourth length L4 is disposed on a part of the area, having patterns, and arranged along the vibration-damping cutter holder 1 axially or non-axially. The first length L1 is larger than or equal to the fourth length L4. The 3D damping member 2 is used for vibration suppression and mainly in close contact with at least one surface of the vibration-damping cutter holder 1 to ensure structural stability and vibration reduction efficiency.

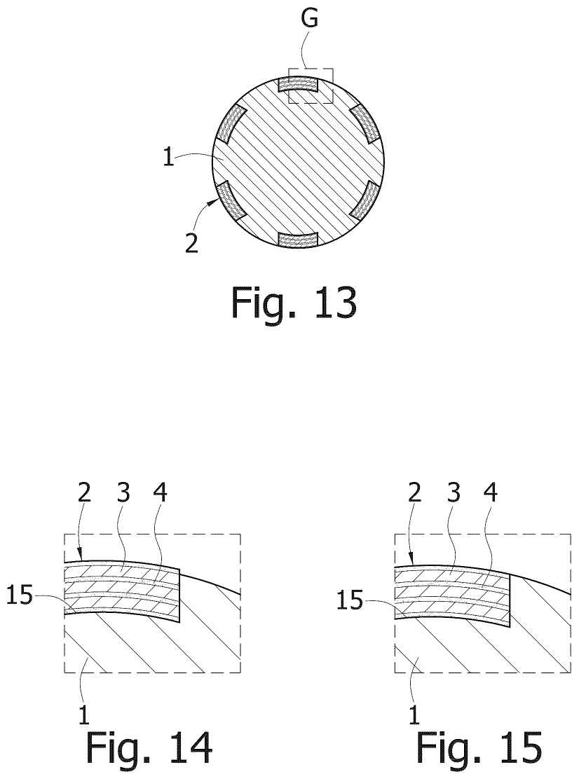

In a second embodiment of the present invention modified based on the above first embodiment, an area on the outer surface 14 of the cutter holder 12, the cutter handle 11, or both the cutter holder 12 and the cutter handle 11 is provided at least one long slot 15 (as shown in FIG. 13-16) having a certain depth and a second length L2 and arranged along the vibration-damping cutter holder 1 axially or non-axially. The 3D damping member 2 with the fourth length L4 is mounted in the long slot 15 and the second length L2 is larger than or equal to the fourth length L4.

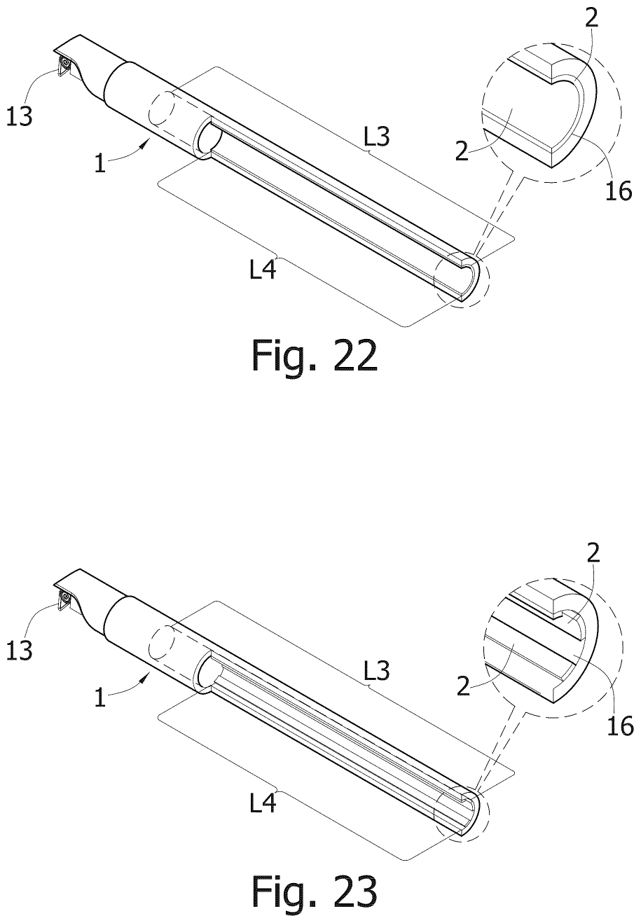

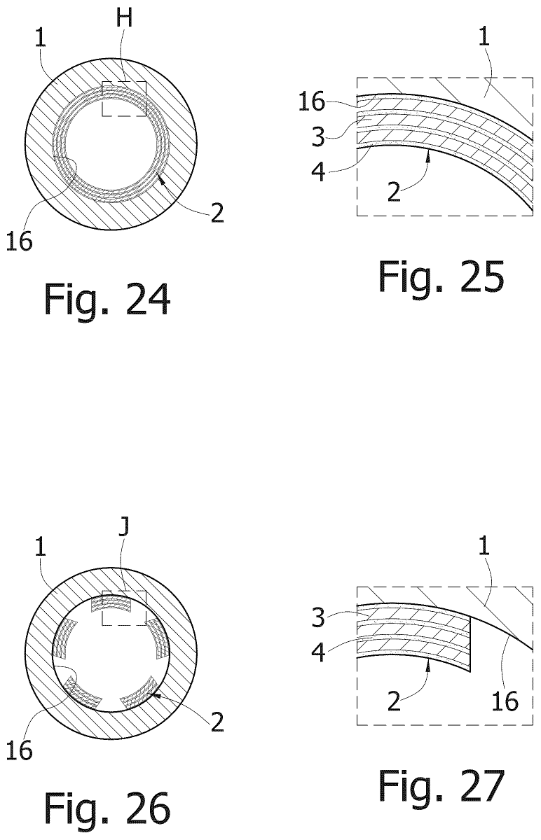

In a third embodiment of the present invention modified based on the above first embodiment, the vibration-damping cutter holder 1 includes an inner surface 16 of a hollow cylinder therein. The inner surface 16 is having a third length L3 in an axial direction. The 3D damping member 2 with the fourth length L4 is arranged at the whole area (as shown in FIG. 22, FIG. 24, and FIG. 25) or a part of the area (as shown in FIG. 23, FIG. 26, and FIG. 27) of the inner surface 16. The third length L3 is larger than or equal to the fourth length L4.

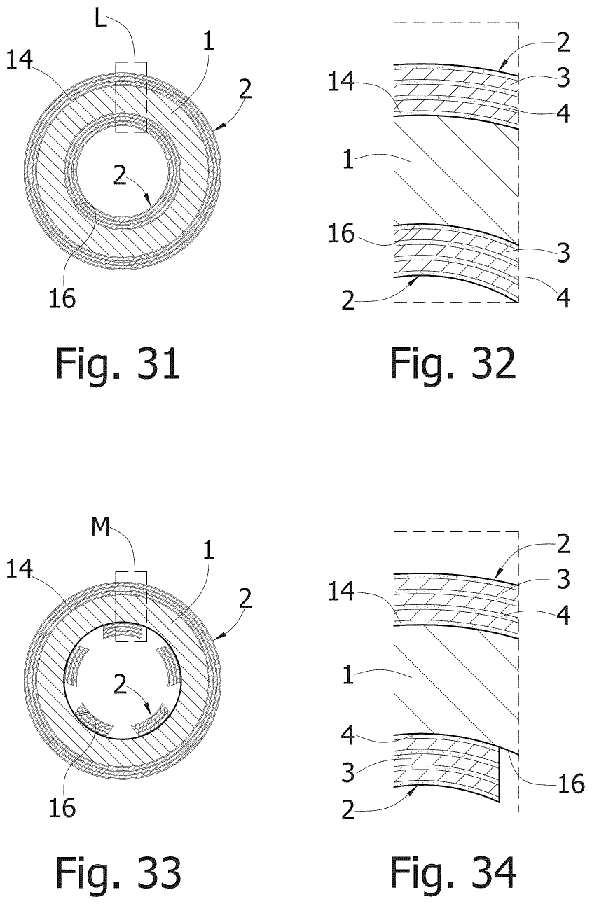

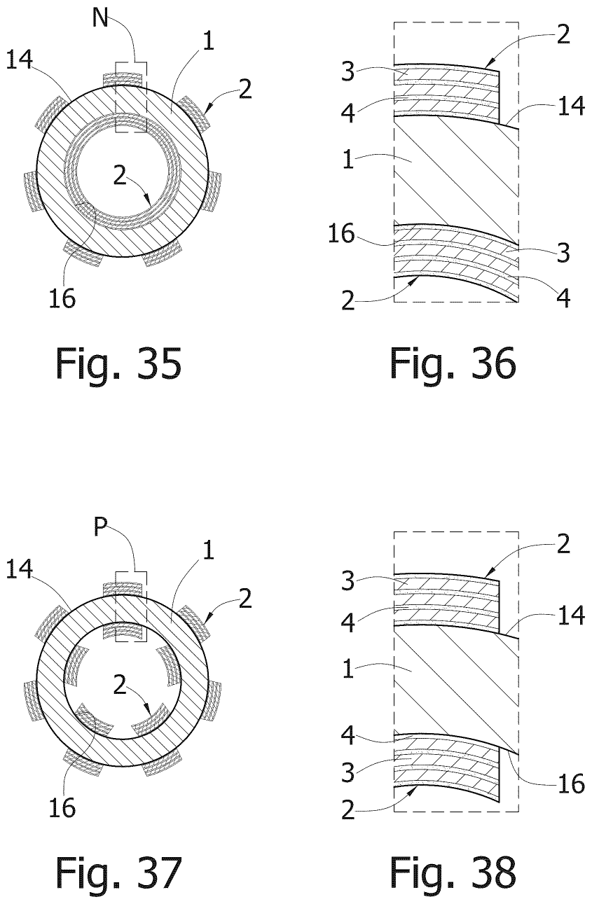

The fourth embodiment of the present invention is a combination of the first embodiment and the third embodiment mentioned above. As shown in FIG. 31-FIG. 38, the cutter handle 11, the cutter holder 12, or both the cutter handle 11 and the cutter holder 12 of the vibration-damping cutter holder 1 is provided with the outer surface 14 and the inner surface 16 is arranged at a hollow space inside the vibration-damping cutter holder 1. The outer surface 14 and the inner surface 16 respectively have the first length L1 and the third length L3 in the axial direction. The 3D damping members 2 used for reduction of vibration are disposed on a part of or the whole area of both the outer surface 14 and the inner surface 16. A length of the 3D damping member 2 is not over the length of the outer surface 14 and the length of the inner surface 16.

The 3D damping members 2 covers most of at least one surface of the vibration-damping cutter holder 1, able to reduce cutting error of the vibration-damping cutter holder 1 caused by vibration created during cutting process. Moreover, the 3D damping members 2 can not only shorten working period and improve production efficiency of on-site cutting but also provide high precision cutting. The 3D damping members 2 includes a plurality layers of an integrated sandwich body composed of at least one kind of the continuous anti-vibration fiber 3 connected with the resin parts 4. The 3D damping members 2 can be extended to a space outside according to user's needs, maintained at a solid form, and closely contacted with a surface of the vibration-damping cutter holder 1. As shown in FIG. 29, an outer surface 14 of the 3D damping members 2 is a top-layer surface 24 and a surface opposite to the top-layer surface 24 is a joint surface 23. The 3D damping members 2 includes a plurality layers of the continuous anti-vibration fiber 3 connected continuously and containing the already cured resin parts 4 between the continuous anti-vibration fiber 3. Thereby the 3D damping members 2 not only has features of no compressibility, no ductility, and a low coefficient of thermal expansion (CTE), but also provides ability to inhibit low-frequency, middle-frequency, and high-frequency vibrations, and excellent damping performance.

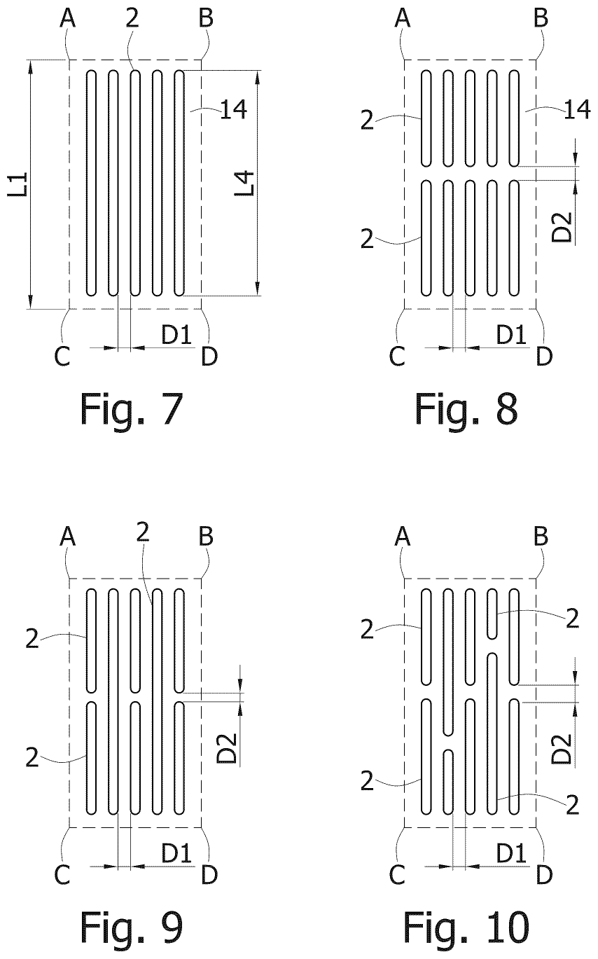

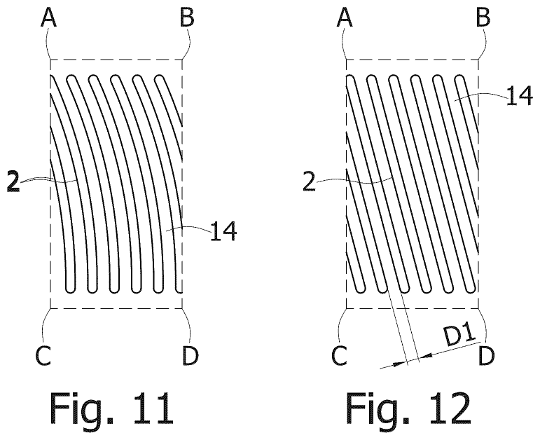

In FIG. 5 and FIG. 6, a modified embodiment of the first embodiment is provided. The area of the outer surface 14 of the cutter handle 11, the cutter holder 12, or both the cutter handle 11 and the cutter holder 12 is having a first length L1 and only a part of the area is covered with the 3D damping members 2 arranged axially (FIG. 7-FIG. 10) or non-axially (FIG. 11-Fig. 12). The plurality of the 3D damping members 2 with a certain width is arranged around a circumference of the vibration-damping cutter holder 1. The 3D damping members 2 can be disposed in parallel to one another and having the same or different interval D1 between the two adjacent 3D damping members 2. Moreover, as shown in FIG. 8-10, a certain distance D2 on the circumference of the long-strip shaped vibration-damping cutter holder 1 is provided as an distance D2 between the two adjacent 3D damping members 2 with certain length and width and corresponding size, contour or shape. According to user's requirements, the shape (size) of the 3D damping members 2 on the outer surface 14 can be adjusted. For example, this modified embodiment includes two kinds of the 3D damping members 2 with different shapes (sizes) disposed on two different positions correspondingly. Each kind of the 3D damping members 2 can be operated independently to deal with the vibrations with different frequencies and strength for vibration reduction and damping effects.

Refer to FIG. 1, FIG. 2, and FIG. 13-15, a second embodiment of the vibration-damping cutter holder 1 is provided. The vibration-damping cutter holder 1 includes a cutter handle 11, a cutter holder 12, and a cutter 13. The outer surface 14 of the cutter handle 11, the cutter holder 12, or both the cutter handle 11 and the cutter holder 12 is provided with at least one the long slot 15 with a preset depth and the second length L2 concavely.

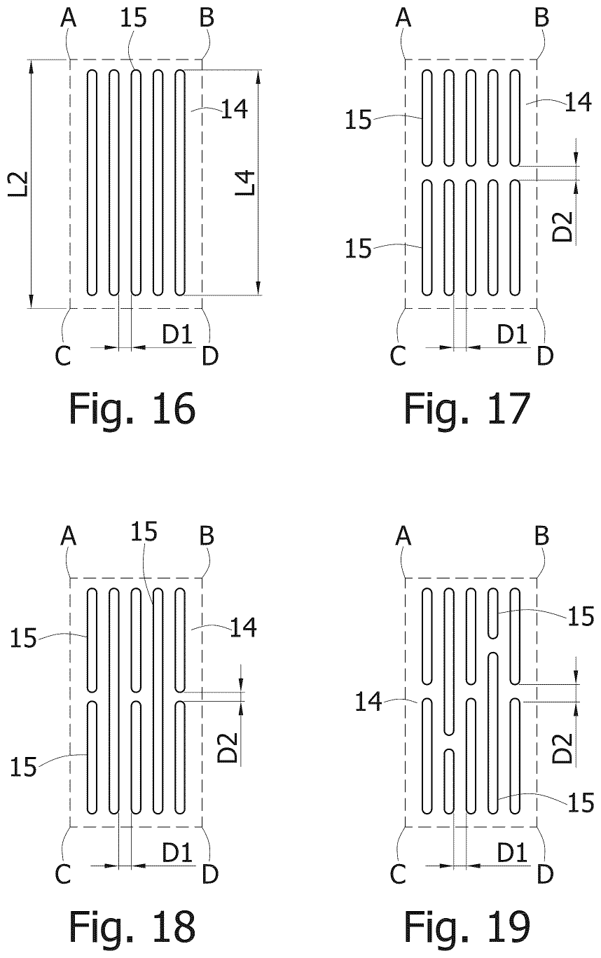

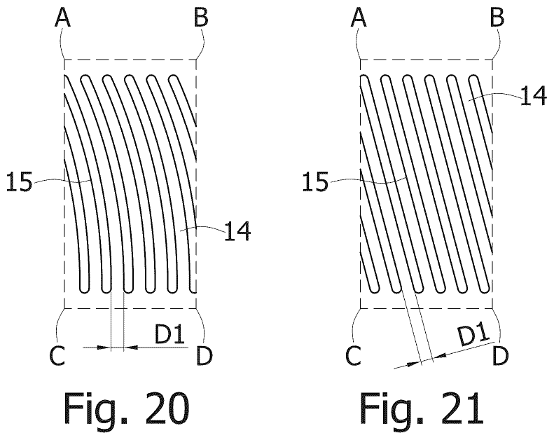

In this embodiment, the vibration-damping cutter holder 1 features on the long slots 15 disposed axially as shown in FIG. 16-19, or non-axially as shown in FIG. 20-21. The plurality of the long slots 15 is arranged at a circumference of the vibration-damping cutter holder 1. The long slots 15 are disposed in parallel to one another with the same or different interval D1 between the two adjacent long slots 15 and having at least two different kinds of sizes, contours and/or shape located at least two different positions. Moreover, as shown in FIG. 17-19, there is an interval D1 and a distance D2 arranged between the two adjacent long slots 15 respectively in parallel to an axial direction and a circumferential direction.

The 3D damping member 2 is mounted in the long slot 15. A certain pressure is applied layer by layer at a specific temperature so that the resin parts 4 are deformed and cured between the anti-vibration fiber 3 and the long slot 15. Thus the 3D damping member 2 is firmly fixed in the long slot 15 by the joint surface 23. After curing, a level of the top-layer surface 24 of the 3D damping member 2 is higher than a level of the outer surface 14 in FIG. 14. Refer to FIG. 15, a level of the top-layer surface 24 of t he 3D damping member 2 is flush with a level of the outer surface 14.

Refer to FIG. 22-Fig. 27, a third embodiment of a vibration-damping cutter holder 1 is provided. The vibration-damping cutter holder 1 includes a cutter handle 11, a cutter holder 12, and a cutter 13. An inner surface 16 of a hollow cylinder is also included in the vibration-damping cutter holder 1 and having the third length L3 in an axial direction.

The features of this embodiment are described below. As shown in FIG. 22, FIG. 24, and FIG. 25, the inner surface 16 is completely covered with the 3D damping member 2. Or as shown in FIG. 23, FIG. 26, and FIG. 27, the inner surface 16 is provided with a plurality of the 3D damping members 2 having the same shape (size) or at least two different shapes (sizes). The respective 3D damping members 2 include a plurality layers of the continuous anti-vibration fiber 3 connected continuously. By a certain pressure being applied layer by layer, the resin parts 4 are deformed and cured between the anti-vibration fiber 3 and the inner surface 16 so that the 3D damping member 2 is securely fixed in the rough inner surface 16 by the joint surface 23. Or the curing is performed according to axial or non-axial arrangement of the inner surface 16 to achieve layer-by-layer stacking of the anti-vibration fiber 3.

The vibration-damping cutter holder 1 made from metals has lower response to vibration reduction and easy to be used as vibration transmission medium. In contrast, each of the respective 3D damping members 2 can be considered as a complete shock absorbing body which effectively absorbs low-frequency, mid-frequency, and high-frequency vibrations generated during operations of tools through the inner and outer surfaces 16, 14 of the vibration-damping cutter holder 1. The resin parts 4 combined with the stacked anti-vibration fiber 3 are used to form the 3D damping members 2 in different forms on the outer surface 14 and the inner surface 16 quickly and fix the 3D damping members 2 at specific positions firmly and stably to meet complicated requirements for the different vibration-damping cutter holders 1. At the same time, the 3D damping members 2 can be connected to the whole or a part of both the outer surface 14 and the inner surface 16 of the vibration-damping cutter holder 1 firmly.

In some preferred embodiments of the present invention, the anti-vibration fiber 3 is selected from materials or properties in the following group consisting of liquid crystal polymer (LCP) fiber, aromatic polyamide (aramid) fiber, carbon fiber, boron fiber, basalt fiber, glass fiber, and a combination thereof. The continuous anti-vibration fiber 3 includes a plurality layers of the above fiber connected continuously. For example, the continuous anti-vibration fiber 3 is formed by at least two kinds of fiber materials with different ingredients or properties and arranged alternately to reach the size and the shape required. In such design, a length direction of at least one layer of the anti-vibration fiber 3 and a length direction of another layer of the anti-vibration fiber 3 are parallel or non-parallel to each other. At the same time, a length direction of the anti-vibration fiber 3 is the same as the direction of the first length L1 while there are no specific limits on volume and weight.

During formation of the anti-vibration fiber 3 with at least two layers connected continuously, the LCP fiber is the best choice among the fiber with single property. The LCP fiber is in a form of a plurality of layers and made from liquid crystal polymer (LCP) which includes polyarylate (PAR), all-aromatic polyester, semi-rigid aromatic polyester, and polyester-amides. Moreover, the LCP can also be copolymer formed by the following raw materials: aromatic or aliphatic dihydroxy compounds, aromatic or aliphatic dicarboxylic acids, aromatic hydroxy carboxylic acid, aromatic diamines, aromatic hydroxylamines, and aromatic amino acids.

The vibration reduction property of the vibration-damping cutter holder 1 can be evaluated by an accelerometer which is used to collect logarithmic decrements (amplitude decay rate). The logarithmic decrement is usually associated with the amplitude and the frequency.

When the vibration-damping cutter holder 1 is made of alloy steel and provided with no 3D damping members 2, use an impact hammer to strike position of the cutter 13 and perform natural frequency test. An average amplitude of three times of measurement is 1184G (refer to attachment 1). After the inner surface 16 of the vibration-damping cutter holder 1 is provided with the 3D damping member 2 having a thickness of 2 mm and 3 mm, the average amplitude of three times of measurement of the cutter 13 is respectively reduced to 863G and 222G under the same test conditions. The results show excellent vibration damping.

In a preferred embodiment, the vibration-damping cutter holder 1 is made of tungsten carbide and provided with no 3D damping members 2, use an impact hammer to strike position of the cutter 13 and perform natural frequency test. An average amplitude of three times of measurement is 1624G (refer to attachment 2). However, after the outer surface 14 of the vibration-damping cutter holder 1 is provided with the 3D damping member 2 having a thickness of 0.3 mm, 1 mm, and 2 mm, the average amplitude of three times of measurement of the cutter 13 is significantly reduced to 636G, 368G, and 248G respectively under the same test conditions. The results show excellent vibration damping performance.

The anti-vibration fiber 3 is formed by unidirectional fiber or unidirectional continuous fiber and mounted in the 3D damping member 2. The anti-vibration fiber 3 is made from liquid crystal polymer (LCP) fiber, aromatic polyamide (aramid) fiber, carbon fiber, boron fiber, basalt fiber, glass fiber, and their combinations. The above fiber is arranged in the form of multiple layers ranging from 3 layers to 15 layers with a thickness between 0.3 mm and 1.2 mm in a full-length or full-width continuous manner. Thereby an integrated structure is provided.

The 3D damping member 2 is produced by the following way. The resin parts 4 are soaked in or coated on a main body of the anti-vibration fiber 3 made of at least one material mentioned above. Then the resin parts 4 are infiltrated into the anti-vibration fiber 3 to form a prepreg. Next a plurality of prepregs are stacked to form a prepreg laminate and cure on a rough surface of the outer surface 14, the long slot 15, or the inner surface 16. Thereby layer-by-layer stacking of the anti-vibration fiber 3 is achieved.

More specifically, the 3D damping member 2 is in an integrally-formed sandwich body which is formed by placing middle layers between surface layers. Each layer is made from the anti-vibration fiber 3 formed by unidirectional fiber or unidirectional continuous fiber. The resin part 4 which is thermosetting resin, thermoplastic resin, degradable epoxy resin composition, or a combination of them is attached inside the anti-vibration fiber 3 and attached to surface area of the anti-vibration fiber 3.

In a preferred embodiment, the resin part 4 is selected from the group consisting of thermosetting resin, thermoplastic resin, degradable epoxy resin composition, or a combination thereof and used together with the anti-vibration fiber 3. By the anti-vibration fiber 3, joint strength between the vibration-damping cutter holder 1 and the 3D damping member 2 is increased and an edge warp of the 3D damping member 2 is reduced. No matter the anti-vibration fiber 3 in the 3D damping member 2 is unidirectional fiber or unidirectional continuous fiber, its optimal content is ranging from 50-80% by weight. In consideration of formability of the resin part 4, an ideal content of the anti-vibration fiber 3 is 50-60% by weight, preferably 60-70% by weight, and particularly preferably 70-80% by weight.

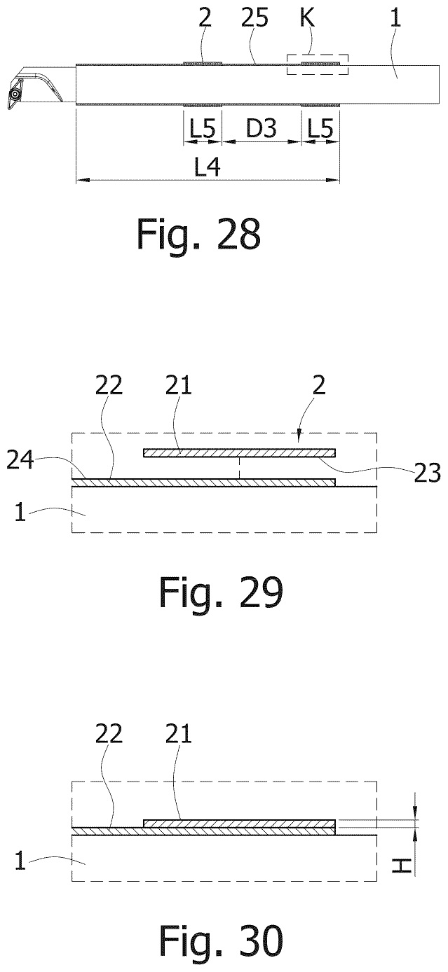

In a further embodiment, the 3D damping member 2 is integrally covering along a circumferential direction of the outer surface 14 and the 3D damping member 2 has a level difference H is disposed on the outer surface 14. As shown in FIG. 28-30, the 3D damping member 2 includes an upper damping laminate 21 and a lower damping laminate 22. The joint surface 23 of the upper damping laminate 21 is joined with a part area of the top-layer surface 24 of the lower damping laminate 22. The level difference H between the top-layer surfaces 24 of the upper and the lower damping laminates 21, 22 is ranging from 0-3 mm. The upper damping laminate 21 is present as a curved surface around the vibration-damping cutter holder 1 in the circumferential direction. A length of the lower damping laminate 22 is the fourth length L4 while a length of the upper damping laminate 21 is a fifth length L5 which is smaller than the fourth length L4.

The level difference H is formed between the top-layer surface 24 of the upper damping laminate 21 and the top-layer surface 24 of the lower damping laminate 22.

More specifically, a recess 25 is arranged between the two upper damping laminates 21 and located at a part area of the top-layer surface 24 of the lower damping laminate 22 axially or non-axially. The recess 25 is extending from the top-layer surface 24 of the upper damping laminate 21 to the top-layer surface 24 of the lower damping laminate 22 and the level difference H is formed between the top-layer surface 24 of the upper damping laminate 21 and the top-layer surface 24 of the lower damping laminate 22.

To be more specific, the lower damping laminate 22 is having the fourth length L4 and a first thickness to form a first sandwich body. A plurality of the upper damping laminates 21 arranged axially or non-axially is having the fifth length L5 and a second thickness to form second sandwich bodies with a preset distance D3 between the two adjacent upper damping laminates 21. The first thickness can be larger, equal to, or smaller than the second thickness. The first thickness of one of the upper damping laminates 21 can be larger, equal to, or smaller than the first thickness of the adjacent upper damping laminate 21.

In a preferred embodiment, the resin part 4 contained and infiltrated in the anti-vibration fiber 3 is thermosetting resin selected from the group consisting of epoxy resin, phenol formaldehyde (PF) resin, epoxy vinyl resin, unsaturated polyester resin, and a combination thereof.

In a further preferred embodiment, the resin part 4 contained and infiltrated in the anti-vibration fiber 3 is thermoplastic resin selected from the group consisting of polyethylene (PE), polypropylene (PP), acrylonitrile butadiene styrene (ABS), ethylene vinyl acetate (EVA), and a combination thereof.

In a further preferred embodiment, the resin part 4 permeated in the anti-vibration fiber 3 is degradable epoxy resin composition. More specifically, the degradable epoxy resin composition includes 50~80% epoxy resin composition and 20~50% curing agent by mass. The degradable epoxy resin composition is added with carbonate ester additive which is micron-sized solid particles in powder form existed in the curing agent. The carbonate ester additive reacts with alkaline solution to have transesterification and cause swelling.

In particular, a first hot pressing of prepreg layup is performed while using molding shrinkage to enclose the prepreg layup or expansion sleeve to stretch the prepreg layup. During a first hot pressing, the prepreg is pressurized by a first pressure at a first temperature to be cured in the outer surface 14, the long slot 15, or the inner surface 16.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A vibration-damping cutter holder comprising
an outer surface disposed on both a cutter handle and a cutter holder, and an inner surface arranged at a hollow space inside the vibration-damping cutter holder;
wherein the inner surface, the outer surface, or both the inner and the outer surfaces is/are provided with a 3-dimensional (3D) damping member; a length of the 3D damping member is not over a length of the inner surface or a length of the outer surface; wherein the 3D damping member includes a plurality of layers of anti-vibration fiber and resin parts infiltrated into the anti-vibration fiber; the anti-vibration fiber is selected from the group consisting of liquid crystal polymer (LCP) fiber, aromatic polyamide (aramid) fiber, carbon fiber, boron fiber, basalt fiber, glass fiber, and a combination thereof; the anti-vibration fiber is arranged at the layers ranging from 3 to 15 layers and connected with the resin parts to form an integrated body.

2. A vibration-damped cutter holder comprising an outer surface disposed on a cutter handle or both a cutter holder;
wherein the outer surface of the cutter handle or the outer surface of the cutter holder is provided with a 3-dimensional (3D) damping member; a length of the 3D damping member 2 is not over a length of the outer surface; wherein the 3D damping member includes a plurality of layers of anti-vibration fiber and resin parts; the anti-vibration fiber is selected from the group consisting of liquid crystal polymer (LCP) fiber, aromatic polyamide (aramid) fiber, carbon fiber, boron fiber, basalt fiber, glass fiber, and a combination thereof; the anti-vibration fiber is arranged at the layers ranging from 3 to 15 layers and connected with the resin parts to form an integrated body.

3. A vibration-damped cutter holder comprising a cutter handle and a cutter holder;
wherein an outer surface of the cutter holder or an outer surface of both the cutter handle and the cutter holder is provided with at least one long slot having a preset depth and a second length arranged axially or non-axially;
a 3-dimensional (3D) damping member with a fourth length is mounted in the long slot and the second length is larger than or equal to the fourth length; wherein the 3D damping member includes a plurality of layers of anti-vibration fiber and resin parts; the anti-vibration fiber is selected from the group consisting of liquid crystal polymer (LCP) fiber, aromatic polyamide (aramid) fiber, carbon fiber, boron fiber, basalt fiber, glass fiber, and a combination thereof; the anti-vibration fiber is arranged at the layers ranging from 3 to 15 layers and connected with the resin parts to form an integrated body.

4. The vibration-damping cutter holder as claimed in claim 1, wherein the 3D damping member includes an upper damping laminate and a lower damping laminate with a level difference between the upper and the lower damping laminates; a joint surface of the upper damping laminate is joined with a part area of a top-layer surface of the lower damping laminate.

5. The vibration-damping cutter holder as claimed in claim 2, wherein the 3D damping member includes an upper damping laminate and a lower damping laminate with a level difference between the upper and the lower damping laminates; a joint surface of the upper damping laminate is joined with a part area of a top-layer surface of the lower damping laminate.

6. The vibration-damping cutter holder as claimed in claim 3, wherein the 3D damping member includes an upper damping laminate and a lower damping laminate with a level difference between the upper and the lower damping laminates; a joint surface of the upper damping laminate is joined with a part area of a top-layer surface of the lower damping laminate.

7. The vibration-damping cutter holder as claimed in claim 1, wherein the resin part infiltrated in the anti-vibration fiber is thermosetting resin selected from the group consisting of epoxy resin, phenol formaldehyde (PF) resin, epoxy vinyl resin, unsaturated polyester resin, and a combination thereof.

8. The vibration-damping cutter holder as claimed in claim 2, wherein the resin part infiltrated in the anti-vibration fiber is thermosetting resin selected from the group consisting of epoxy resin, phenol formaldehyde (PF) resin, epoxy vinyl resin, unsaturated polyester resin, and a combination thereof.

9. The vibration-damping cutter holder as claimed in claim 3, wherein the resin part infiltrated in the anti-vibration fiber is thermosetting resin selected from the group consisting of epoxy resin, phenol formaldehyde (PF) resin, epoxy vinyl resin, unsaturated polyester resin, and a combination thereof.

10. The vibration-damping cutter holder as claimed in claim 1, wherein the resin part infiltrated in the anti-vibration fiber is thermoplastic resin selected from the group consisting of polyethylene (PE), polypropylene (PP), acrylonitrile butadiene styrene (ABS), ethylene vinyl acetate (EVA), and a combination thereof.

11. The vibration-damping cutter holder as claimed in claim 2, wherein the resin part infiltrated in the anti-vibration fiber is thermoplastic resin selected from the group consisting of polyethylene (PE), polypropylene (PP), acrylonitrile butadiene styrene (ABS), ethylene vinyl acetate (EVA), and a combination thereof.

12. The vibration-damping cutter holder as claimed in claim 3, wherein the resin part infiltrated in the anti-vibration fiber is thermoplastic resin selected from the group consisting of polyethylene (PE), polypropylene (PP), acrylonitrile butadiene styrene (ABS), ethylene vinyl acetate (EVA), and a combination thereof.

13. The vibration-damping cutter holder as claimed in claim 1, wherein a length direction of at least one of the layers of the anti-vibration fiber and a length direction of another one of the layers of the anti-vibration fiber are parallel or non-parallel to each other.

14. The vibration-damping cutter holder as claimed in claim 2, wherein a length direction of at least one of the layers of the anti-vibration fiber and a length direction of another one of the layers of the anti-vibration fiber are parallel or non-parallel to each other.

15. The vibration-damping cutter holder as claimed in claim 3, wherein a length direction of at least one of the layers of the anti-vibration fiber and a length direction of another one of the layers of the anti-vibration fiber are parallel or non-parallel to each other.
